(19) United States
(12) Patent Application Publication
(10) Pub. No.: US 2009/0108075 A1
(43) Pub. Date: Apr. 30, 2009

(54) Sealed housing with integral window and integral pressure indicator in electro-optical reader

(76) Inventors: Igor Vinogradov, Bay Shore, NY (US); Carl Wittenberg, Water Mill, NY (US)

Correspondence Address: KIRSCHSTEIN, ISRAEL, SCHIFFMILLER & PIERONI, P.C., 425 Fifth Avenue, 5TH FLOOR, New York, NY, 10016-2223, US

(21) Appl. No.: 11/981,448

(22) Filed: Oct. 31, 2007

(51) Int. Cl. G06K 7/10; G06K 9/24

(52) U.S. Cl. 235/462.42; 235/435; 235/462.43; 235/473

(57) ABSTRACT

A reader for electro-optically reading indicia, includes a sensor for sensing light from the indicia, and for generating a signal indicative of the indicia. A support includes a housing in which the sensor is contained, and a light-transmissive window through which the light from the indicia passes en route to the sensor. The window and the housing are both constituted of a same moldable material and are integrally molded together as a single component of one-piece, seamless construction. A pressure indicator is also integrally formed with the housing, for visually indicating pressure within the housing.

### BACKGROUND OF THE INVENTION

Various electro-optical readers have previously been developed for reading both one- and two-dimensional bar code symbols appearing on a label, or on a surface of a target. The bar code symbol itself is a coded pattern of indicia. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

Moving beam electro-optical readers have been disclosed, for example, in U.S. Pat. No. 4,251,798; U.S. Pat. No. 4,369,361; U.S. Pat. No. 4,387,297; U.S. Pat. No. 4,409,470; U.S. Pat. No. 4,760,248; and U.S. Pat. No. 4,896,026. Typically, a housing contains a laser for generating a laser beam that is directed through a window on the housing toward a one- or two-dimensional coded symbol. The laser beam is repetitively swept in a scan line or a series of scan lines across the symbol for reflection therefrom by means of motion of a scanning component, such as a scan mirror, in the housing. A sensor or photodetector, together with a collection lens assembly comprised of one or more lenses, all mounted in the housing, capture and detect laser light reflected or scattered from the symbol and entering the window. The sensor generates an electrical analog signal indicative of the laser light returning from the symbol. Electronic control circuitry and software decode the analog signal into a digital representation of the data represented by the symbol that has been scanned. The binary data may then be converted into the alphanumeric characters represented by the symbol. The data may be decoded locally or sent to, and decoded in, a remote host for subsequent information retrieval.

Both one- and two-dimensional symbols can also be read by employing an imaging reader having a housing containing a solid-state imager which includes a one- or two-dimensional array of cells or photosensors which correspond to image elements or pixels in a field of view of the imager. A collection lens assembly comprised of one or more lenses in the housing captures either ambient light reflected or scattered from the symbol in the case of a brightly lit environment, or illumination light directed at the symbol for reflection and scattering therefrom in the case of a dimly lit environment in response to actuation of a trigger. The captured light is directed through the window to the imager, which may advantageously be a one- or two-dimensional charge coupled device (CCD) or a complementary metal oxide semiconductor (CMOS) device and includes associated circuits for producing electronic signals indicative of the captured light and corresponding to a one- or two-dimensional array of pixel information over the field of view. The electronic signals may be processed by a microprocessor either locally or sent to, and processed in, a remote host to read the symbol from the captured light.

As advantageous as such moving beam and imaging readers are in capturing data as stand-alone data capture systems, such a reader can be a relatively large and expensive component in assembly and manufacture, especially if it is installed in an apparatus in which the reader is a subsystem. For example, a coffee maker is an example of an apparatus in which the reader may be installed to read symbols on packets of coffee in order to instruct the coffee maker how to brew a particular packet. The reader is a subsidiary system in the coffee maker and, therefore, its design must be optimized such that its size, as well as its assembly and manufacturing costs, are minimized.

It is therefore known to mount various optical and electrical components of a reader in a housing to protect the components from moisture, dirt, dust and like contaminants present in the environment, and to enable easier integration into other apparatus. It is also known to use an adhesive to adhere the window, which is a separate, discrete, relatively expensive part made of plastic or glass, to the housing However, in some applications, such as the coffee maker described above, the window must be separately handled and accurately positioned on, and adhered and well sealed to, the housing to prevent moisture, hot water, and steam generated during brewing of the coffee from contaminating the components inside the housing and causing reader malfunction and failure. Moisture can also develop in the housing as a result of condensation when ambient temperature falls. Seal integrity is typically verified by test equipment. It is difficult to seal the discrete window, and to check seal integrity, economically. A manufacturer is not likely to use an uneconomic, large-sized reader, especially in an apparatus with little room to spare.

### SUMMARY OF THE INVENTION

One feature of this invention resides, briefly stated, in a reader for, and a method of, reading indicia. The reader may be an imaging reader for electro-optically reading indicia, such as bar code symbols, by capturing illumination and/or ambient light reflected or scattered from the symbols with an array of image sensors of a solid-state, one- or two-dimensional, sensor or imager, or a moving beam reader for electro-optically reading indicia, again such as bar code symbols, by scanning the symbols with a laser beam, and by detecting laser light reflected or scattered from the symbols with a sensor, such as a photodiode.

The reader includes a support having a housing in which the sensor is contained, and a light-transmissive window through which the light from the indicia passes en route to the sensor. In accordance with one feature of this invention, the window and the housing are both constituted of a same moldable material, preferably plastic, and are integrally molded together as a single component of one-piece, seamless construction. Thus, it is no longer necessary to manufacture the window as a separate, discrete part, that has to be separately handled and accurately positioned on, and adhered and well sealed to, the housing to prevent moisture and contaminants from entering the housing. There is no seam between the window and the housing that has to be sealed.

In a preferred embodiment, the reader includes an imaging lens in the housing, for optically modifying and capturing the light passing in one direction through the window for delivery to the sensor. The reader also includes an illuminator in the housing, for emitting illumination light in an opposite direction through the window toward the indicia for scattering therefrom. The illuminator preferably includes a single light source or light emitting diode (LED), but may include a plurality of light sources or LEDs, and a lightpipe in the housing. The lightpipe is constituted of an optical material, and is operative for optically guiding the illumination light from the light source(s) toward the indicia. The sensor is operative for sensing the illumination light scattered from the indicia.

The window and the housing are preferably constituted of the same moldable material that is transmissive to the illumination light. Thus, if the LED emits a red-colored light, then the window and the housing are preferably molded of a red-colored, light-transmissive material. A transparent material can be used to allow all light to pass. If the moldable material is a soft plastic, then a light-transmissive, scratch-resistant, hard, protective coating, such as polysiloxane, is advantageously applied on the window to improve scratch resistance.

A printed circuit board (PCB) is assembled to the housing, for supporting the sensor, the illuminator and the lightpipe. The PCB may be directly sealed to the housing by an adhesive, or, as is preferred, the PCB may be fitted inside the housing, and a generally planar, rigid base plate, preferably of plastic material, is positioned underneath the PCB and is sealingly adhered to the housing.

In accordance with another feature of this invention, a pressure indicator is integrally molded with the housing, for visually indicating pressure within the housing. The pressure indicator is a flexible wall portion of the housing. The flexible wall portion is deformable in response to a pressure differential on opposite sides of the flexible wall portion. The flexible wall portion has a convex curvature when the pressure inside the housing is greater than the pressure outside the housing, a concave curvature when the inside pressure is less than the outside pressure, and a generally planar shape when the inside pressure is generally equal to the outside pressure. Thus, by merely looking at the shape of the flexible wall portion, seal integrity can be verified.

The integral window and the integral pressure indicator reduce assembly and manufacturing costs and promotes the use of the reader as a miniature component in a non-stand-alone apparatus, such as the coffee maker described above, or a myriad of other apparatuses, such as a telephone, a mobile computer, or the like where space is at a premium.

The method of electro-optically reading indicia includes the steps of sensing light from the indicia with a sensor operative for generating a signal indicative of the indicia; containing the sensor in a housing, and passing light from the indicia en route to the sensor with a light-transmissive window; and integrally molding the window and the housing together of a same moldable material as a single component of one-piece, seamless construction. Still another step comprises integrally forming a pressure indicator with the housing, for visually indicating pressure within the housing.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a housing with an integral window and an integral pressure indicator in a reader for electro-optically reading indicia in accordance with this invention;

FIG. 2 is a block circuit diagram of various components of an imaging reader employing the housing shown in FIG. 1;

FIG. 3 is a diagrammatic view of a portable electro-optical moving beam reader in which the housing shown in FIG. 1 may be employed;

FIG. 4 is a sectional view of the housing shown in FIG. 1 showing the components of FIG. 2 in a practical embodiment;

FIG. 5 is an enlarged sectional view of the pressure indicator of FIG. 1 when the pressure inside the housing matches the pressure outside the housing;

FIG. 6 is a view analogous to FIG. 5 when the inside pressure is less than the outside pressure; and

FIG. 7 is a view analogous to FIG. 5 when the inside pressure is greater than the outside pressure.

### DETAILED DESCRIPTION OF THE PREFERRED EMBODIMENTS

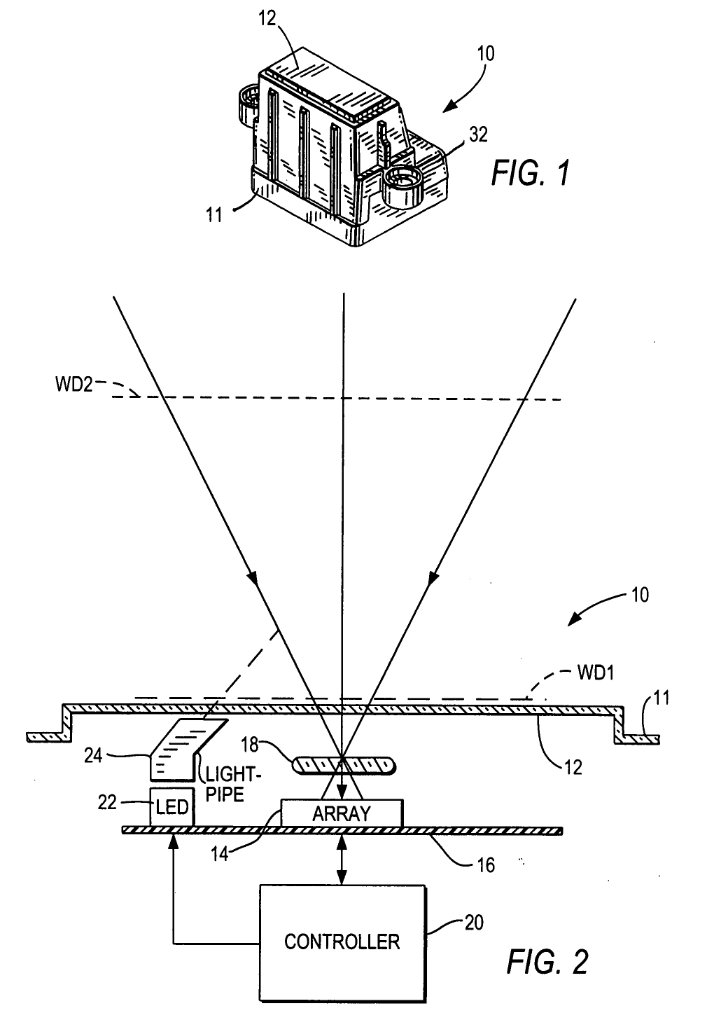

Reference numeral 10 in FIG. 1 generally identifies a data capture system or an electro-optical imaging reader for electro-optically reading indicia, such as bar code symbols, by capturing illumination and/or ambient light reflected or scattered from the symbols with an array of image sensors. In use, an operator presents each symbol to be read to a window 12 of a housing 11. The reader 10 can be used as a stand-alone device, but has been especially designed herein to be portable, miniature, lightweight and inexpensive so that it can be readily installed as a subsidiary component in an apparatus operative for performing other functions.

As shown in FIGS. 2 and 4, the imaging reader 10 includes an imager 14 supported on a printed circuit board (PCB) 16 in the housing 11, and a focusing imaging lens 18 located in front of the imager. The imager 14 is a solid-state device, for example, a CCD or a CMOS device and preferably has a linear array of addressable image sensors operative for sensing light passing through the window 12 and captured by the lens 18. The light is reflected or scattered from a target symbol, for example, a one-dimensional symbol, over a field of view and located in a working range of distances between a close-in working distance (WD1) and a far-out working distance (WD2). In a preferred embodiment, WD1 is about one inch from the imager array 14 and generally coincides with the window 12, and WD2 is about two inches from the window 12.

An illuminator is also mounted in the housing 11 and preferably includes a light source, e.g., a light emitting diode (LED) 22, to illuminate the target symbol especially in a dimly lit environment where ambient light is insufficient for the reader to operate. A lightpipe 24 is operative for optically guiding and delivering the illumination light from the LED 22 through the window 12 to the indicia. To help minimize specular reflection, an upper portion of the lightpipe 24 is inclined at a steep angle of inclination, e.g., 45°, relative to the window 12 and the board 16. Hence, the specular component of the light reflected from the indicia is directed well away from the imager at the same steep angle of inclination. A lower portion of the lightpipe 24 is generally perpendicular to the window 12 and the board 16. The sensor is operative for sensing the illumination light scattered from the symbol.

As also shown in FIG. 2, the imager 14 and the LED 22 are operatively connected to a controller or microprocessor 20 operative for controlling the operation of these components. Preferably, the microprocessor is the same as the one used for decoding the light from the symbol and for processing the captured target symbol images.

In operation, the microprocessor 20 sends a command signal to the LED 22 to pulse the LED for a short time period of 500 microseconds or less, and energizes the imager 14 to collect light captured by the lens 18 from the symbol substantially only during said time period. A typical array needs about 33 milliseconds to read the entire target image and operates at a frame rate of about 30 frames per second. The array may have on the order of one thousand, preferably 1500, addressable image sensors.

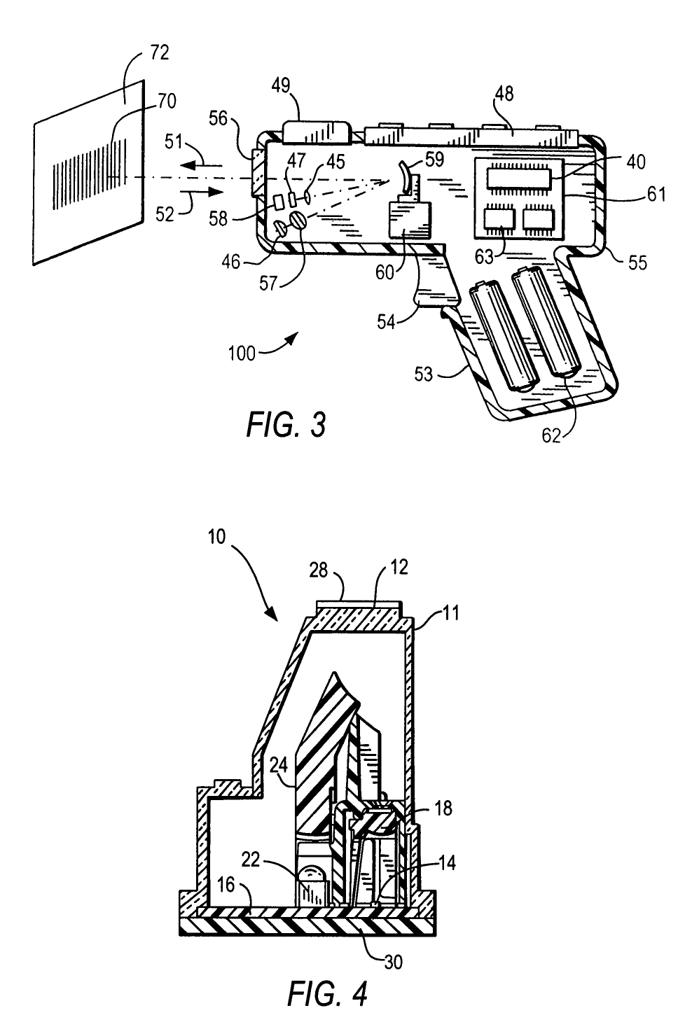

As an example of another type of data capture system or reader in which the present invention may be used, reference numeral 100 in FIG. 3 generally identifies a portable handheld moving beam reader for electro-optically reading bar code symbols. The reader 100 is preferably implemented as a gun-shaped device, having a pistol-grip handle 53. A lightweight plastic housing 55 contains a light source 46, a light sensor 58, a focusing lens 57, signal processing circuitry 63, a programmed controller or microprocessor 40, and a power source or battery pack 62. An operator aims the reader at a bar code symbol 70 on a target 72. A window 56 at a front end of the housing 55 allows an outgoing light beam 51 to exit and incoming return light 52 scattered or reflected from the symbol to enter.

The focusing lens 57 focuses the light beam 51 into a scanning spot at an appropriate reference plane. The light source 46, such as a semiconductor laser diode, introduces a light beam into an optical axis of the lens 57. The beam is reflected from an oscillating mirror 59 that is coupled to a scanning drive motor 60 energized when a trigger 54 is manually pulled. The oscillation of the mirror 59 causes the outgoing beam 51 to scan back and forth in a desired pattern, such as a scan line or a raster pattern of scan lines, across the symbol.

The return light 52 reflected or scattered back by the symbol passes back through the window 56 for transmission to the sensor 58, preferably a photodiode. The return light reflects off the mirror 59, is captured by a light collection lens 45, passes through an optical bandpass filter 47, and impinges on the sensor 58. The filter 47 is designed to have a bandpass characteristic in order to pass the captured return laser light and block the light coming from other optical sources. The sensor 58 produces an analog signal proportional to the intensity of the captured return light 52.

The signal processing circuitry includes a digitizer 63 mounted on a printed circuit board 61. The digitizer processes the analog signal from detector 58 to produce a pulse signal where the widths and spacings between the pulses correspond to the widths of the bars and the spacings between the bars of the symbol. The digitizer serves as an edge detector or wave shaper circuit, and a threshold value set by the digitizer determines what points of the analog signal represent bar edges. The pulse signal from the digitizer 63 is applied to a decoder, typically incorporated in the programmed microprocessor 40 which will also have associated program memory and random access data memory. The microprocessor decoder 40 first determines the pulse widths and spacings of the signal from the digitizer. The decoder then analyzes the widths and spacings to find and decode a legitimate bar code message. This includes analysis to recognize legitimate characters and sequences, as defined by the appropriate code standard. This may also include an initial recognition of the particular standard to which the scanned symbol conforms. This recognition of the standard is typically referred to as autodiscrimination. A keyboard 48 and a display 49 may advantageously be provided on a top wall of the housing for ready access thereto.

To scan the symbol, the operator aims the bar code reader 100 and operates the movable trigger switch 54 to activate the light source 46, the scanning motor 60 and the signal processing circuitry. If the scanning light beam 51 is visible, the operator can see a scan pattern on the surface on which the symbol appears and adjust aiming of the reader 100 accordingly. If the light beam 51 produced by the source 46 is marginally visible, an aiming light may be included. The aiming light, if needed, produces a visible light spot that may be fixed, or scanned just like the laser beam 51. The operator employs this visible light to aim the reader at the symbol before pulling the trigger.

In accordance with one feature of this invention, the window 12 of FIGS. 1, 2, 4 or the window 56 of FIG. 3 is integrally molded together with the housing 11 of FIGS. 1, 2, 4 or the housing 55 of FIG. 3, respectively. Both the window and the housing are constituted of a same moldable material, for example, plastic or glass, and are a single component of one-piece, seamless construction. Thus, it is no longer necessary to manufacture the window as a separate, discrete part, that has to be separately handled and accurately positioned on, and adhered and well sealed to, the housing to prevent moisture and contaminants from entering the housing. There is no seam between the window and the housing that has to be sealed.

The window and the housing are preferably constituted of the same moldable material that is transmissive to the illumination light. Thus, if the LED 22 emits a red-colored light, then the window and the housing are preferably molded of a red-colored, light-transmissive material. A transparent material can be used to pass all colors of light. If the moldable material is a soft plastic, then a light-transmissive, scratch-resistant, hard, protective coating 28 (see FIG. 4), such as polysiloxane, is advantageously applied on the window to improve scratch resistance.

The PCB 16 is assembled to the housing 11, for supporting the sensor 14, the imaging lens 18, the illuminator 22 and the lightpipe 24. The PCB 16 may be directly sealed to the housing 11 by an adhesive, or, as is preferred, the PCB 16 may be fitted inside the housing 11, and a generally planar base plate 30, preferably of a rigid plastic material, is positioned underneath the PCB 16 and is sealingly adhered to the housing 11.

In accordance with another feature of this invention, a pressure indicator 32 (see FIG. 1) is integrally molded with the housing 11, for visually indicating pressure within the housing. The pressure indicator 32 is a flexible wall portion of the housing and is formed by making a selected area of one of the wall portions of the housing thin. The flexible wall portion of reduced thickness acts as a membrane and is deformable in response to a pressure differential on opposite sides of the flexible wall portion.

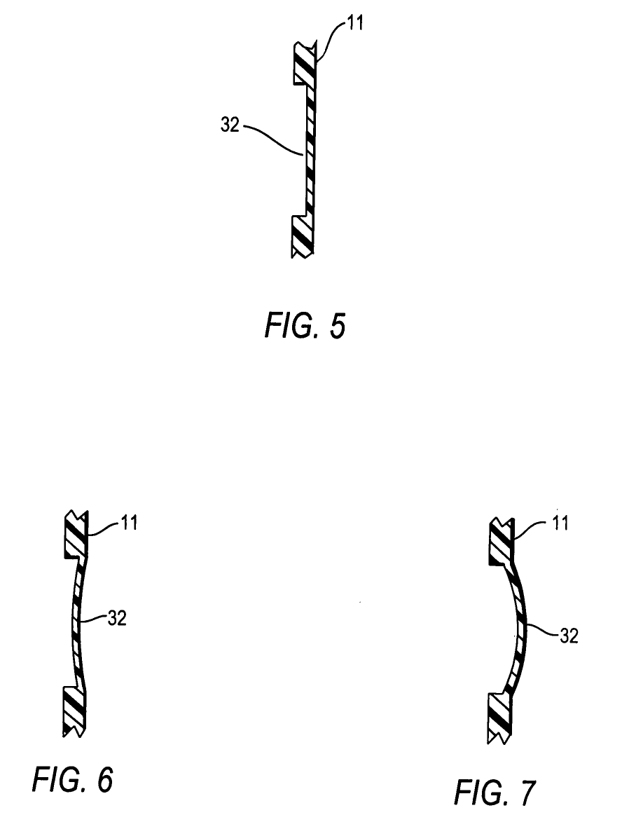

As shown in FIG. 7, the flexible wall portion has a convex curvature when the pressure inside the housing (on the left side of the indicator 32) is greater than the pressure outside the housing (on the right side of the indicator 32). As shown in FIG. 6, the flexible wall portion has a concave curvature when the inside pressure is less than the outside pressure. As shown in FIG. 5, the flexible wall portion has a generally planar shape when the inside pressure is generally equal to the outside pressure. Thus, by merely looking at the shape of the flexible wall portion, seal integrity can be verified.

To prevent moisture and contaminants from the ambient environment from entering the housing, and to prevent condensation from forming inside the housing due to falling temperatures, the housing is hermetically and tightly sealed shut. The housing is preferably purged with a purge gas, such as nitrogen. The internal pressure within the housing can be above or below atmospheric pressure.

Instead of merely looking at the shape of the flexible wall portion with one's eyes, a light beam can be projected onto the pressure indicator of each sealed housing being conveyed along a production line. A reflection of the light beam can be detected by a camera sensor. The size of the beam spot on the camera sensor will vary with the curvature of the indicator 32, thereby enabling the pressure differential to be easily detected.

The integral window and the integral pressure indicator reduce assembly and manufacturing costs and promotes the use of the reader as a miniature component in a non-stand-alone apparatus, such as the coffee maker described above, or a myriad of other apparatuses, such as a telephone, a mobile computer, or the like where space is at a premium.

It will be understood that each of the elements described above, or two or more together, also may find a useful application in other types of constructions differing from the types described above.

While the invention has been illustrated and described as embodied as an integral window and an integral pressure indicator in an electro-optical reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading indicia, comprising:
a sensor for sensing light from the indicia, and for generating a signal indicative of the indicia; and
a support having a housing in which the sensor is contained, and a light-transmissive window through which the light from the indicia passes en route to the sensor, the window and the housing both being constituted of a same moldable material and being integrally molded together as a single component of one-piece, seamless construction.

2. The reader of claim 1, and an imaging lens in the housing, for optically modifying and capturing the light passing through the window, and wherein the sensor is a solid-state imager for receiving the light optically modified and captured by the lens.

3. The reader of claim 1, wherein the support includes a printed circuit board assembled to the housing, for supporting the sensor.

4. The reader of claim 1, and an illuminator in the housing, for emitting illumination light toward the indicia for scattering therefrom, and wherein the sensor is operative for sensing the illumination light scattered from the indicia.

5. The reader of claim 4, and a lightpipe in the housing and constituted of an optical material, for optically guiding the illumination light from the illuminator toward the indicia.

6. The reader of claim 5, wherein the support includes a printed circuit board assembled to the housing, for supporting the illuminator and the lightpipe.

7. The reader of claim 4, wherein the window and the housing are constituted of the same moldable material that is transmissive to the illumination light.

8. The reader of claim 1, and a light-transmissive, scratch-resistant coating on the window.

9. The reader of claim 1, and a pressure indicator integrally molded with the housing, for visually indicating pressure within the housing.

10. The reader of claim 1, wherein the pressure indicator is a flexible wall portion of the housing, and wherein the flexible wall portion is deformable in response to a pressure differential on opposite sides of the flexible wall portion.

11. The reader of claim 10, wherein the flexible wall portion has a convex curvature when the pressure inside the housing is greater than the pressure outside the housing, a concave curvature when the inside pressure is less than the outside pressure, and a generally planar shape when the inside pressure is generally equal to the outside pressure.

12. A reader for electro-optically reading indicia, comprising:
a sensor for sensing light from the indicia, and for generating a signal indicative of the indicia;
a support having a housing in which the sensor is contained, and a light-transmissive window through which the light from the indicia passes en route to the sensor; and
a pressure indicator integrally formed with the housing, for visually indicating pressure within the housing.

13. The reader of claim 12, wherein the pressure indicator is a flexible wall portion of the housing, and wherein the flexible wall portion is deformable in response to a pressure differential on opposite sides of the flexible wall portion.

14. The reader of claim 13, wherein the flexible wall portion has a convex curvature when the pressure inside the housing is greater than the pressure outside the housing, a concave curvature when the inside pressure is less than the outside pressure, and a generally planar shape when the inside pressure is generally equal to the outside pressure.

15. A reader for electro-optically reading indicia, comprising:
means for sensing light from the indicia, and for generating a signal indicative of the indicia;
housing means for containing the sensing means, and light-transmissive window means for passing the light from the indicia en route to the sensing means; and
means integrally formed with the housing means, for visually indicating pressure within the housing means.

16. A method of electro-optically reading indicia, comprising the steps of:
sensing light from the indicia with a sensor operative for generating a signal indicative of the indicia;
containing the sensor in a housing, and passing light from the indicia en route to the sensor with a light-transmissive window; and
integrally molding the window and the housing together of a same moldable material as a single component of one-piece, seamless construction.

17. The method of claim 16, and emitting illumination light toward the indicia for scattering therefrom, and sensing the illumination light scattered from the indicia.

18. The method of claim 17, and constituting the window and the housing of the same moldable material that is transmissive to the illumination light.

19. The method of claim 16, and visually indicating pressure within the housing by integrally molding a pressure indicator with the housing.

20. A method of electro-optically reading indicia, comprising the steps of:
sensing light from the indicia with a sensor operative for generating a signal indicative of the indicia;
containing the sensor in a housing, and passing light from the indicia en route to the sensor with a light-transmissive window; and
integrally forming a pressure indicator with the housing, for visually indicating pressure within the housing.
